(19) United States
(12) Patent Application Publication
(10) Pub. No.: US 2016/0288346 A1
(43) Pub. Date: Oct. 6, 2016

(54) Razor Blade Holder/Scrapper

(71) Applicant: Gregory Anderson, Santa Barbara, CA (US)

(72) Inventor: Gregory Anderson, Santa Barbara, CA (US)

(21) Appl. No.: 14/677,978

(22) Filed: Apr. 3, 2015

(51) Int. Cl. B26B 5/00; A47L 13/08

(52) U.S. Cl. CPC B26B 5/006; A47L 13/08

(57) ABSTRACT

The present invention propose a flat blade holder comprising, a hand gripping case, a blade mounted inside of said casing and carrying the blade having a cutting edge, said case defining a chamber with first and second opposed slide surfaces and an opening to the outside of said case, a pressure actuated locking means for locking the blade in a first retracted position with a blade carried therein wholly within the chamber and a second operative position with a cutting edge exposed through the opening, locking means comprising cutouts in the middle of the upper part of the casing actuated by finger pressure from outside of the case to release said locking means.

### REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

(1) Field of the Invention

This invention relates generally to blade cover. Specifically, the invention relates to a plastic blade cover, wherein the blade is alternately retractable into housing for storage, and extending from the housing for use or replace.

(2) Background of the Invention

Blade holder has been known for many, many years. More recently, the plastic body blade holder has come into use because of ease of manufacture and reduction in cost over well-known metallic handle. Such holders are commonly used for scraping paint and other unwanted materials from surfaces such as glass surfaces and the like.

Particularly a plastic slider holding a razor blade for movement to encase or to operative positions, locking means for holding the blade in position against the scraping forces encountered are sometimes problems to properly design. Because of the softer nature of plastic as opposed to metal, high, scraping forces sometimes causes dislogdment of the locking means and blade.

There are other priories known holders that do not use screws, but do use specially shaped blades or mounting hooks to secure the blades in place. Such blades are not only more costly, but are also somewhat difficult to assemble and disassemble, and of course such blades are not readily adaptable for use with different holders and the like. An example of a specially constructed blade which has a pronounced natural curvature, requiring the degree of curvature to be reduced during assembly to place the blade in a stressed condition for urging the blade into constant secure retention on the support. Few USA patent shows a blade with an in turned hook at one end and a specially formed snap hook at the other end which is used with a holder having a plane bottom length greater than the distance between the two hooks so that when the Ins turned hook is secured to the holder, the snap hook will exert pressure and tightly secure the file blade to the holder.

These prior art blade holders are either expensive to manufacture, requiring separate elements such as springs, handles, holders, locking and fastening elements, etc., are relatively clumsy to use in terms of changing the blade, or do not securely and positively engage the blade for fail safe operation.

Blade in common usage can be inherently dangerous devices when in the hands of young children. Once the razor blade is exposed, sharper cutting edge presents a serious hazard to unwary handlers of the device. In most known blade, it is extremely simple to move the blade from an inoperative enclosed position to its operative position as by the use of a single button or slide easily operable by young children.

Many of the above problems have been overcome by the current invention The safety feature for the blade storage compartment commonly associated with plastic blade holders still remains unresolved and the current invention targets to overcome this drawback of the prior art.

### SUMMARY OF THE INVENTION

It is an object of this invention to provide a plastic blade cover having a slide carrying a blade for movement between an operative and an inoperative position and also having a blade storage compartment with safety means for locking the blade storage compartment in the inoperative position of the slide.

It is a principal object of this invention to provide an improved blade cover or blade holder for securely retaining the blade in place during use while permitting the blade to be changed with relative ease without the need for any tools and the like.

Still another object of this invention is to provide a plastic blade holder which can be reused and also disposable.

Still another object of this invention is to provide a plastic blade cover in accordance with the preceding objects which can be efficiently manufactured from plastic materials and has desirable strength and rigidity for a wide variety of scraping applications while allowing safe handling of the device when in the inoperative position.

It is a feature of this invention that when the blade is in the inoperative position in the casing, a small child cannot easily release the blade and cannot open the blade storage compartment. Thus, two manipulations must be carried out by the user simultaneously in order to expose the blade for cutting and scraping and enable opening of the blade storage compartment.

To the accomplishment of the foregoing and related ends, the invention, then, comprises the features hereinafter fully described and particularly pointed out in the detailed description, the following description and the annexed drawings setting forth in detail a certain illustrative embodiment of the invention, this being indicative, however, of but one of the various ways in which the principles of the invention may be employed.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

FIG. 1 is a perspective view of the preferred embodiment of the plastic holder with assembly constructed in accordance with the principles of the present invention.

FIG. 2 is a side elevational view of the invention in an operational configuration.

FIG. 3 is an enlarged side elevational view of a section of the invention as set forth in FIG. 2

FIG. 4 is an enlarged side elevational view of an edge portion of the present invention as set forth in FIG. 2.

FIG. 5 is a cross sectional view of the present invention.

### DETAILED DESCRIPTION OF THE INVENTION

The following description of a plastic blade cover is demonstrative in nature and is not intended to limit the scope of the invention or its application of uses.

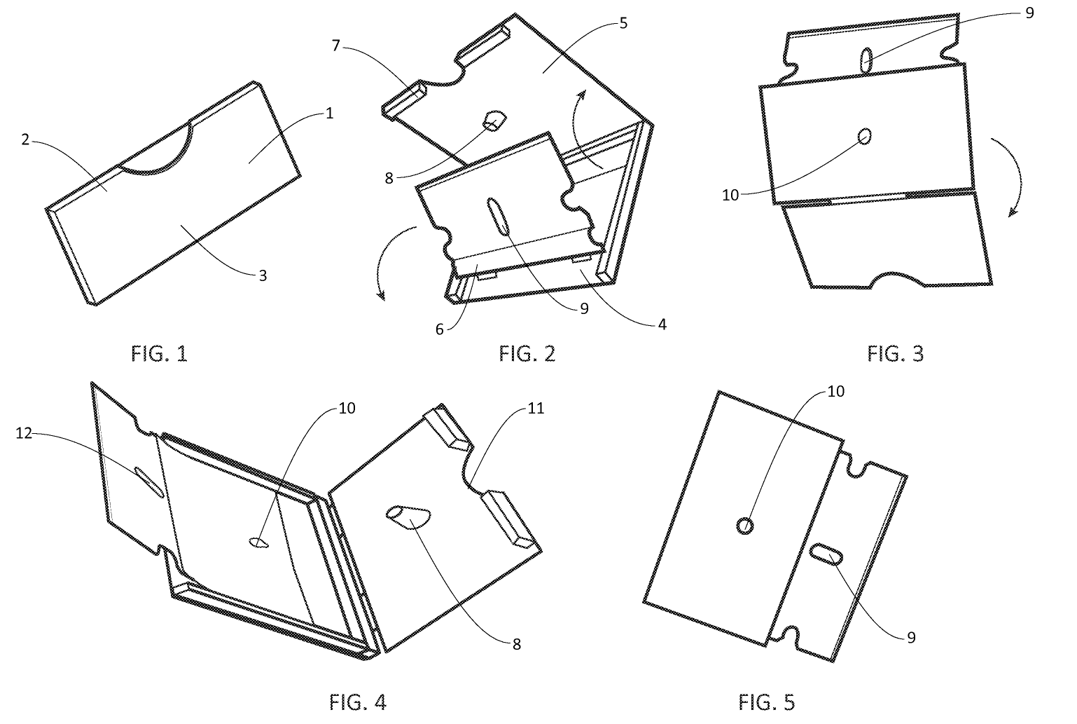

With reference now to the drawings, a preferred embodiment of a plastic cover of the blade is shown generally in FIG. 1, carrying a blade holding slide in a chamber at a forward section with a rear section defining a storage compartment of the holder.

The casing is designed to be comfortably held in the hand of the user to allow scraping with the device held at an angle to a surface such as a window to be scraped of paint. The rear storage compartment is formed by a bottom wall with upstanding walls with one of the walls having a cutout therein. Walls have upstanding ribs, which mate with the walls when the upper lid is closed. A resilient locking tab extends outwardly from a wall of the lid and is designed to pass within the recess and be snapped against a front wall of the blade holding section. Blade, sharp portion is formed on the outside of the side walls so it can pass beneath the lid and pull the lid up from its locked position. The lid snaps into its closed position as shown in FIG. 5 upon applying finger pressure to the lid. The compartment is designed to have sufficient size to store conventional single edge blades. The forward section of the casing has a front wall, a rear wall and side walls define with the front and rear walls, the slide chamber which has an opening through which the slide passes to expose the blade knife edge in the operative position of the holder. Walls provide surfaces which are preferably parallel and on which the slide is mounted for reciprocal sliding to the positions shown in FIGS. 2, 4, 5.

The slide which holds a blade therein, and moves it from an inoperative encased position to an operative position and beyond for exchanging the blade, is shown generally in FIG. 4. Preferably it is formed as an integral piece of a resilient plastic such as polystyrene, Delrin, Acetal or the like.

According to the invention, a plastic blade cover has a casing with an enclosed blade storage compartment which can also save the use of cardboard that regular blades come packaged in. A slide with means for mounting and carrying the cutting blade is positioned within a portion of the casing and the slide moves in a chamber which in turn defines an opening preferably at an end of the casing. A pressure activated locking means is provided for locking the slide and blade in a first retracted position with the blade wholly within and encased by the chamber and in a second position with the blade moved through the opening and exposed out of the chamber in an operative position. A pressure actuated safety means provides a safety lock to hold the slide and blade in the first position while permitting release of the slide upon pressure actuation so that pressure must be applied both to the safety means and locking means simultaneously to expose the blade. A second safety means comprises a stop means for preventing the opening of the cover unless the locking means and safety means are actuated to move the slide from the first position.

It is a feature of this invention to provide a safe lock which requires pressure actuation at two distinct points in order to un-sheath the blade. This feature makes it difficult for young children or others to release and un-sheath the blade by mistake or tampering as opposed to conventional devices which require pressure actuation at a single point. Moreover, the blade used is last longer than a regular blade since it is covered by the blade. Also, the razor blade is not a full blade. It is only a half blade. In addition, this blade holder can be reused and it is also disposable and beneficial for those who having garages or tool sheds.

While a specific embodiment of this invention has been shown and described, many variations thereof are possible. For example, the locking nibs attached to complementary surfaces and can be employed in a wide variety of conventional the blade to provide positive wedging action co-acting against scraping force. The specific configuration of parts can vary in many cases. While the generally rectangular outline is preferred with an enlarged case or compartment section for conformity to the hand of the user, other shapes can be used. Similarly, while all parts of the device are preferably formed of molded plastics, other materials can be used for portions or the entire device if desired. While a storage compartment is preferred for ease of storing spare blades.

From the foregoing, it will now be apparent that the blade plastic holder of the present invention includes a relatively simple and inexpensive mechanism for securely retaining the blade in place during use while permitting the blade to be removed and replaced with relative ease without the use of any tools and the like.

While the invention has been described in conjunction with preferred specific embodiments thereof, it will be understood that this description is intended to illustrate and not to limit the scope of the invention.

I claim:

1. A flat blade holder comprised of:
a hand gripping case having an opening;
a blade mounted inside of said case;
a chamber;
a safety button;
a stop means; and
a pressure actuated locking means for locking said blade.

2. The flat blade holder of claim 1 wherein said blade mounted inside of said case and carrying a blade having a cutting edge.

3. The flat blade holder of claim 1 wherein said case defining a chamber with first and second opposed blade surfaces.

4. The flat blade holder of claim 1 wherein said pressure actuated locking means for locking said blade in a first retracted position with a blade within said chamber.

5. The flat blade holder of claim 1 wherein said pressure actuated locking means for locking said blade in a second operative position with the cutting blade edge exposed through said opening.

6. The flat blade holder of claim 1 wherein said locking means comprising cutouts in the middle of the upper part of said case actuated by finger pressure from outside said case to release said locking means.

7. The flat blade holder of claim 1 wherein said hand gripping case defining a hinged blade storage compartment.

8. A flat blade holder of claim 1 that includes said safety button engaged on the middle of top surface inside of the upper part of said case.

9. A flat blade holder of claim 1 wherein said stop means associated with said locking means for limiting lateral movement of the blade when said locking means is in rest position.

10. A flat blade holder of claim 1, wherein said case not covering a whole blade.

11. Method of use of blade holder includes the attachment of blade on the said case, which is further rotatable and moves outward the shard portion of the blade.

12. Method of use of blade holder of claim 12 wherein said case is fixed with the help of upper covering and its said lock.

13. Method of use of blade holder of claim 12 wherein said case allows the rotating hinges joint inside of the cover and helps in the movement of the blade inward and outward.
